(19) United States
(12) Patent Application Publication
(10) Pub. No.: US 2011/0263293 A1
(43) Pub. Date: Oct. 27, 2011

(54) MOBILE DEVICE INTERFACE FOR USE IN A VEHICLE

(75) Inventors: Tyler Blake, Rancho Santa Margarita, CA (US); Freeman Thomas, Laguna Beach, CA (US); Matthew Edwards, Laguna Beach, CA (US); Andrei Markevich, Aliso Viejo, CA (US)

(73) Assignee: FORD GLOBAL TECHNOLOGIES, LLC, Dearborn, MI (US)

(21) Appl. No.: 12/765,185

(22) Filed: Apr. 22, 2010

(51) Int. Cl. H04W 92/00

(52) U.S. Cl. 455/557

(57) ABSTRACT

A vehicle system is provided with a docking station for receiving a personal device, a controller in communication with the docking station, and a display interface for a vehicle in communication with the controller. The display interface is configured to present at least one menu option from the personal device for occupant selection to control the operation of the personal device to perform the operation in response to the occupant selecting the at least one menu option.

### TECHNICAL FIELD

Various embodiments relate to an information display and user interface for a vehicle.

### BACKGROUND ART

Personal devices, such as mobile telephones, cellular telephones, personal digital assistants, and the like, have become more common over the last few decades. The personal devices are mobile, such that they may be used anywhere by the user. The personal devices may also have the capability of connecting to a network, such as a cellular network, local area network (LAN), or the like, which provide a connection for a telephone call or for data transfer. As the personal devices have become more advanced, they have begun to include navigation capability with global positioning systems and other applications or programs. The personal devices may be capable of SMS (short message service) and MMS (multimedia messaging service) for other communication purposes. The personal devices commonly store the user's contacts, calendar, and other personal information.

Safety concerns have led to restrictions on the use of personal devices while driving in some locations, for example, restrictions on telephone calls or text messaging while driving the vehicle. This has coincided with the use of wireless communication devices such as Bluetooth™ protocol devices including headsets or car kits, synchronized with the personal device to provide for handsfree operation of the personal device. As the use of the personal devices, including smartphones, increases, the need to safely integrate the device with a vehicle during use also increases.

### SUMMARY

In one embodiment, a vehicle system is provided with a docking station for receiving a personal device, a controller in communication with the docking station, and a display interface for a vehicle in communication with the controller. The display interface is configured to present at least one menu option from the personal device for occupant selection to control the operation of the personal device to perform the operation in response to the occupant selecting the at least one menu option.

A further embodiment discloses that the docking station is adapted to receive a telephone.

An even further embodiment discloses that the display interface is provided with a touch screen.

A further embodiment provides at least one switch located on the steering wheel, in communication with the controller to allow for selection of the at least one menu option displayed on the display interface to control the operation of the personal device.

An even further embodiment provides a dial connected to the controller, having both a rotational input and a push input to control the controller to transmit at least one control signal to control the personal device to perform the operation in response to the occupant selecting the at least one menu option.

A further embodiment discloses that the dial is provided with a face as an additional display screen.

An even further embodiment discloses that the docking station is provided with a data connection system to interface with the personal device.

A further embodiment discloses that the docking station is provided with an ejection assembly to eject the personal device from the docking station.

An even further embodiment discloses that the display interface is adapted to be mounted on an instrument panel of the vehicle.

A further embodiment discloses that the display interface is adapted to be mounted on a dashboard of the vehicle.

An even further embodiment discloses that the controller is in communication with a vehicle controller to receive a vehicle state input.

A further embodiment discloses that the controller is configured to operate the system in a park mode based on the vehicle state input.

An even further embodiment discloses that the display interface is configured to present the at least one menu option relating to at least one of data and program applications on the personal device during the park mode.

A further embodiment discloses that the controller is configured to operate the system in a drive mode based on the vehicle state input.

An even further embodiment discloses that the controller is configured to limit the display interface to present the at least one menu option relating to at least one of data and applications on the phone during the drive mode, and configured to disable at least one of text, email, and internet.

A further embodiment discloses that at least one of phone and navigation are enabled during the drive mode.

An even further embodiment provides a voice command system in communication with the controller for receiving voice inputs from the occupant to control the operation of the personal device.

Another embodiment discloses a method including connecting a personal device to a controller in a vehicle, presenting at least one menu option from the personal device for occupant selection via an interface display, and controlling the operation of the personal device using a control signal generated in response to the occupant selecting the at least one menu option.

In an embodiment, an information display system for a vehicle is provided with an information display and a controller connected to the information display and configured to connect to a personal device. The information display is configured to display one of a plurality of selectable display levels from the personal device for occupant selection. The controller is configured to receive and selectively transmit the plurality of selectable display levels from the personal device to the display, and the controller is also configured to receive at least one occupant input corresponding to one of the plurality of selectable display levels and transit the at least one input to the personal device.

A further embodiment is provided with at least one display control switch, wherein the occupant input corresponds to activation of the of the least one display control switch.

### BRIEF DESCRIPTION OF THE DRAWINGS

FIG. 1 is a perspective view of a vehicle interior with a vehicle system according to an embodiment;

FIG. 2 is a perspective view of a vehicle system according to another embodiment;

FIG. 3 is a perspective view of the vehicle system of FIG. 2 in use;

FIG. 4 is a perspective view of a vehicle system according to a further embodiment;

FIG. 5 is a perspective view of a vehicle system according to another embodiment; and

FIG. 6 is a perspective view of a vehicle system according to yet another embodiment.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

While labels may be assigned to the various controllers and/or electrical components disclosed, such labels are not intended to limit the scope of operation for the controllers and/or the electrical components. The controllers (or modules) may be combined with each other and/or separated in any manner based on the particular type of electrical architecture that is desired or intended to be implemented in the vehicle.

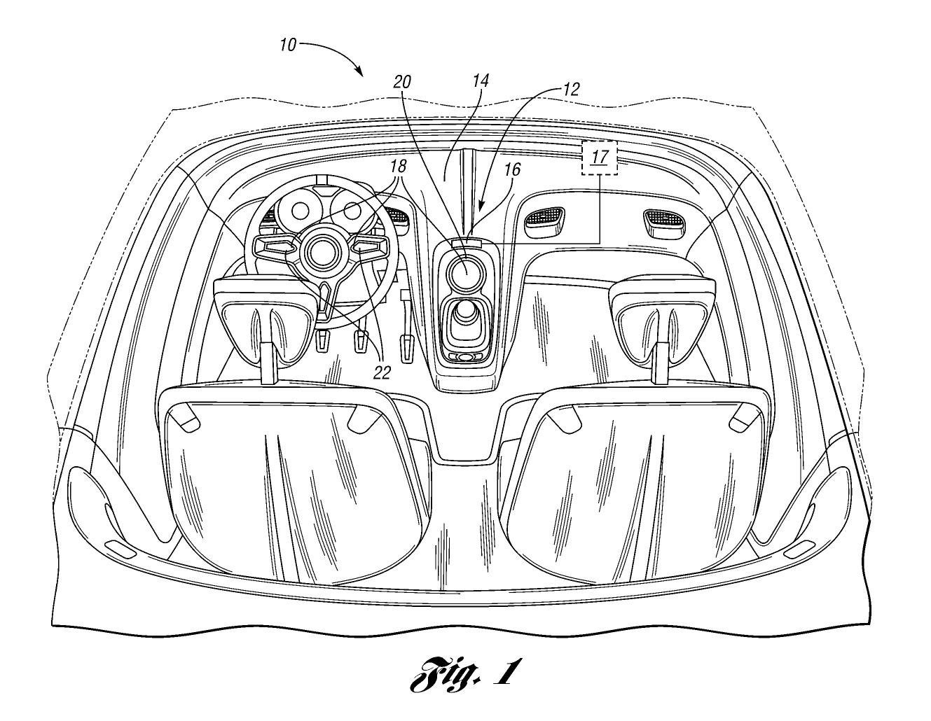

FIG. 1 illustrates a vehicle interior 10 having a vehicle system 12. The vehicle system 12 may interact with a personal device such as a cellular telephone, personal digital assistant, dataphone, or the like to provide an interface for the vehicle's occupants to use the device while in the vehicle interior 10. The vehicle system 12 is shown as being primarily located on the dashboard 14 of the vehicle interior 10, although the vehicle system 12 may also be mounted on a center console, instrument panel, or other interior component.

The personal device connects to the vehicle system 12 using a docking station 16. The personal device may also connect wirelessly in another embodiment. The docking station 16 is connected to a controller 17 in order to control the personal device using switches 18, such as dial 20 or steering wheel switches or toggles 22. The vehicle occupants, such as the driver, front seat passenger, or others, provide inputs to the personal device using the switches 18.

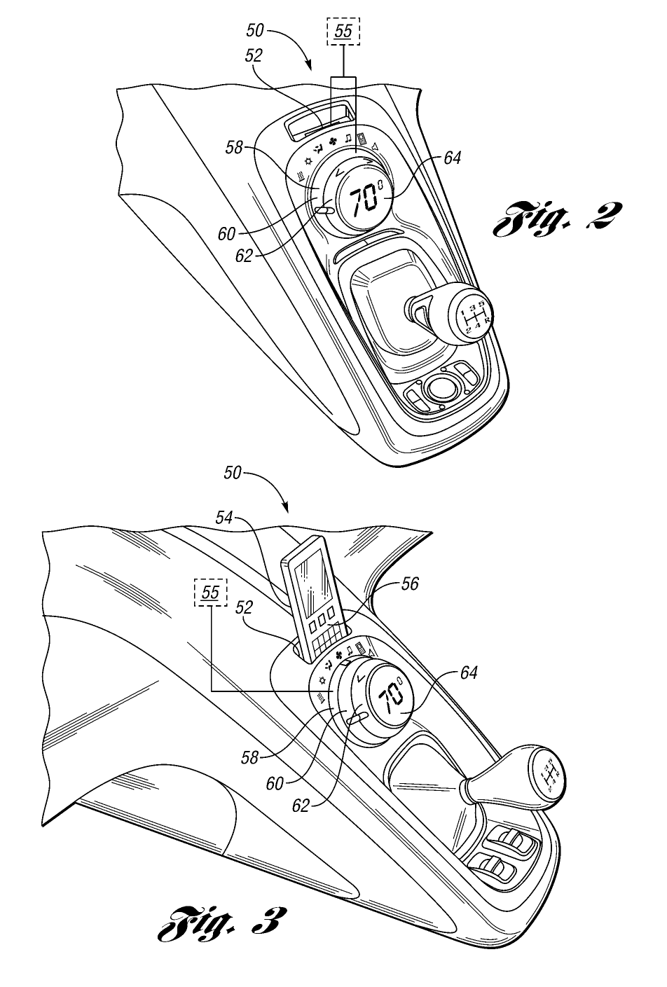

FIGS. 2-3 illustrate another embodiment of the vehicle system 50. The vehicle system 50 has a docking station 52 to receive a personal device 54. The personal device 54 is held securely by the docking station 52 and is in communication with a controller 55 for the vehicle system 50. The docking station 52 contains an electrical connector such as pins, universal serial bus, micro-USB (universal serial bus), or the like to act as a data connection system. Alternatively the docking station may contain changeable hardware to interface with the personal device or a network capability to link with the personal device wirelessly. The docking station 52 may also provide electrical power for the personal device for charging the battery or running the device on auxiliary power. The docking station 52 allows for different personal devices to be used with the vehicle system 50.

The personal device 54 has a screen 56, which may have a touch screen interface. When the personal device 54 is mounted into the docking station 52, it is linked with the controller 55 via the docking station 52. Switches, such as the dial 58, provide inputs from the occupant to the controller 55 to operate the personal device 54. The dial 58 may be capable of providing multiple inputs to the controller 55. In one embodiment, the dial 58 has a first rotational ring 60 function, a second rotational ring 62 function, and a push function. The first rotational ring 60 and second rotational ring 62 may be turned by the occupant either in a clockwise or counterclockwise direction. This may provide a scrolling or selecting input to the controller 55 for the personal device 54. The dial 58 may also have a push function, where the face 64 of the dial may be depressed to act as an input to the controller 55 for the personal device 54.

In one embodiment, the face 64 of the dial 58 additionally is provided with an information display. The dial face 64 may display information from the personal device 54 or relating to the vehicle.

The docking station 52 is in communication with a controller 55 and receives the personal device 54. The controller 55 is configured to present at least one menu option or display level from the personal device 54 for selection by the vehicle occupant. Once the occupant has made a selection, the controller 55 controls the operation of the personal device 54 to perform the selected menu option.

Previous interfaces in vehicles operate using a specific user interface system that is unique to the interface. The occupant has to learn the interface system through the use of tutorials or the like. With the present vehicle system 50, the interface with the personal device appears with screens and menu options from the occupant's personal device. The occupant, being familiar with the use of their personal device is familiar with the operation and visual interface of the device leading to a more intuitive operation of the vehicle system 50. This may also reduce the need for vehicle system 50 tutorials, increase ease of use, and allow for personalizing any vehicle equipped with a vehicle system 50. Vehicle safety may also be improved as the driver is familiar with the interface system 50 and can focus more on driving.

In one embodiment, the controller 55 also receives an input from a vehicle controller (not shown) regarding a vehicle state input. The vehicle controller may be configured to transmit vehicle transmission status signals to the controller 55 corresponding to whether the vehicle is in the “PARK”, “NEUTRAL”, “REVERSE”, and “DRIVE” positions. Further, the vehicle controller may also monitor parking brake status as an input to the controller 55. The controller 55 then operates the personal device 54 in a “park mode” or a “drive mode” based on the input received from the vehicle controller. In the park mode, the vehicle has either the transmission in “PARK” or the parking brake engaged. During park mode, all of the applications and data stored on the personal device 54 are accessible by a vehicle occupant when the personal device is connected to the vehicle system 50. In the drive mode, the vehicle has either the transmission in “DRIVE”, “NEUTRAL”, “REVERSE”, or other gear. During the drive mode, the controller 55 limits the availability of some of the applications or data on the personal device 54. This may lead to safer vehicle operation by a driver, reduced distractions on the road, or assisting the vehicle occupants with complying with local regulations regarding vehicle operation and the use of personal devices 54.

The personal device 54 may contain data or program applications such as a telephone, text messaging, internet capability, electronic mail, user calendar, user contacts, navigation and global positioning capability, music, photograph or video library and player, and other applications chosen by the user for use on the personal device 54. The personal device 54 may also contain wireless communication capability, such as Bluetooth™ protocol capability, and voice-to-text capability. The controller 55 may limit use of some of these functions while operating the vehicle system 50 in the drive mode. For example, the email, internet, text messaging, video library, or applications such as games may be disabled during the drive mode. In another embodiment, the telephone function of the personal device may only operate using wireless communication capability during the drive mode. During the drive mode, the navigation for example may remain active for use by the vehicle occupants. The contacts may also remain active to provide addresses as a database for the navigation.

In another embodiment, a voice command system (not shown) provides voice inputs from the occupant to the controller to operate the personal device 54 while in the vehicle system 50.

A vehicle occupant may use the dial 58, a voice command, or another switch to scroll through the various fields of text and select menu options from the personal device 54. In another embodiment, the screen 56 of the personal device 54 may also be used to provide inputs to the device 54.

According to an embodiment, the occupant places the personal device 54 into the docking station 52, thereby connecting the device 54 to the vehicle system 50. While in the park mode, the occupant uses the dial 58, such as the first ring 60 or second ring 62, or other input to go from a home screen on the personal device 54 and select an application on the device 54, such as ‘contacts’, ‘calendar’, email, or the like by scrolling through the options as they appear on the screen 56 of the device 54. The occupant then selects the desired program, for example, ‘contacts’, by pushing the dial 58. The controller 55 then signals the device 54 to operate in ‘contacts’ and the screen 56 of the device 54 reflects this. The occupant then scrolls through the contacts to select one. Upon selection of a contact by another push of the dial 58, the contact data field for that contact appears on the device display 56. Information regarding the contact may also appear on the face 64 of the dial 58. The occupant the has the option to select a phone number to dial, an address for navigation, or an email address to begin an electronic message to the contact. Another switch on the dial 58 is used to move backwards through the menu options towards the home screen of the device 54.

According to another embodiment, the occupant places the vehicle into drive mode, and some of the features of the device 54 are limited or disabled. While in the drive mode, the occupant uses the dial 58, voice input, or other input to go from a home screen on the personal device 54 to select an application on the device 54, such as ‘contacts’, navigation, phone, or the like by scrolling through the options as they appear on the screen 56 of the device 54. Some programs, such as email or internet, are disabled and either no longer appear on the device 54 home screen or are unselectable by the occupant. The occupant then selects an available desired program, for example, ‘contacts’, by pushing the dial 58. The controller 55 then signals the device 54 to operate in ‘contacts’ and the screen 56 of the device 54 reflects this. The occupant then scrolls through the contacts to select one using the dial 58, another switch, or a voice command. Upon selection of a contact by a push of the dial 58, the contact data field for that contact appears on the device display 56. Information regarding the contact may also appear on the face 64 of the dial 58. The occupant then selects an address for navigation, or a phone number to dial. Electronic mail to the contact, or other disabled options are unavailable while the vehicle system 50 operates in drive mode. Another switch on the dial 58 is used to move backwards through the menu options towards the home screen of the device 54. Other methods of operating the system 50 using various switches, programs, or devices are also contemplated.

FIG. 4 illustrates another embodiment of a vehicle system 70 having a cradle 72 acting as the docking station and mounted on the dashboard 74 of the vehicle. The personal device 76 is placed into the cradle 72, which connects the personal device 76 to the controller 77 of the vehicle system 70 and additionally secures the device 76. Multiple cradles may be provided with the system 70 to fit into the dashboard 74 for use with different personal devices 76.

Once the personal device 76 is connected to the vehicle system 70, it is controlled using switches 78 on the steering wheel, touch capability on the information display, voice commands, or any combination thereof. The switches 78 may also be used to control the vehicle HVAC, entertainment center, and other operations. The operation of the vehicle system 70 is similar to that described previously with reference to FIGS. 2-3.

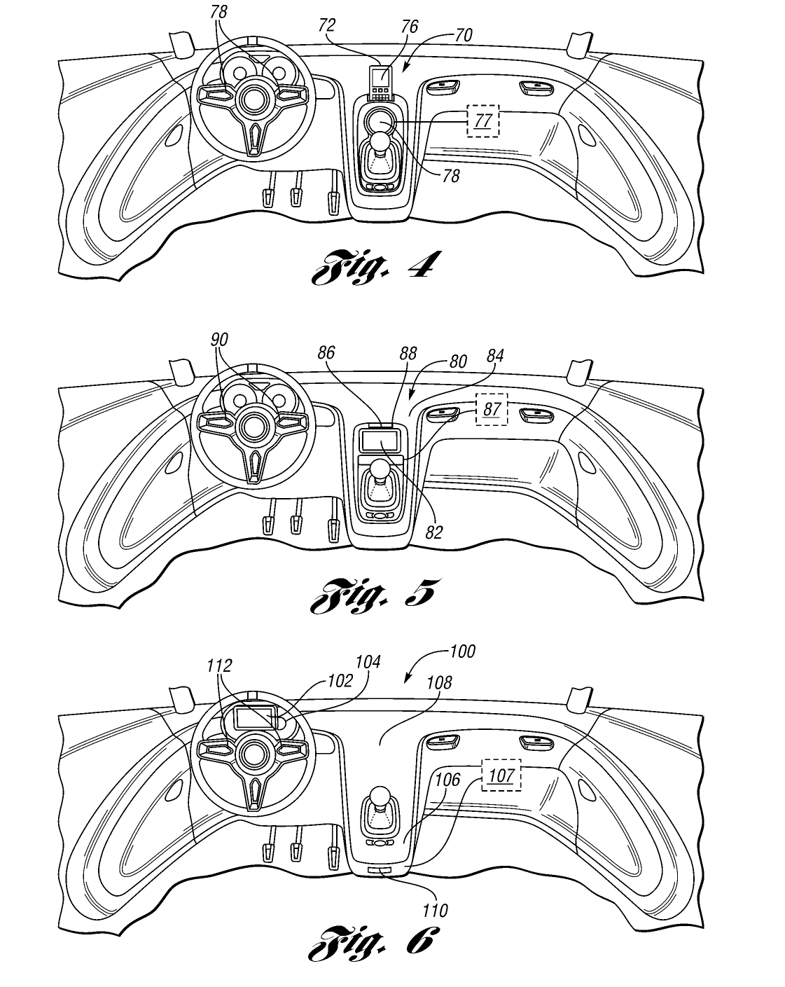

FIG. 5 illustrates an embodiment of a vehicle system 80 having an information display 82 within the vehicle interior and mounted on the dashboard 84 of the vehicle. The information display 82 is a liquid crystal display (LCD), a plasma display, an organic light emitting display (OLED), or any other suitable display, and may include thin film transistor (TFT) technology or the like. The display 82 provides information to the vehicle occupants regarding the vehicle stereo system, HVAC system, or other vehicle operations. In addition, the information display 82 is used with a personal device connected to a docking station 86 connected to a controller 87 of the vehicle system 80. The docking station 86 is internal to the dashboard 84, and has an aperture 88 through which the personal device is inserted to connect to the docking station 86. The personal device is therefore located out of view of the occupants during use with the vehicle system 80. An ejection assembly, as is known in the art, is provided to eject the personal device from the docking station 86, and may include an ejection button.

Once the personal device is connected to the vehicle system, it is controlled using switches 90 on the steering wheel, touch capability on the information display 82, voice commands, or any combination thereof. In one embodiment the switches 90 are also used to control the vehicle HVAC, entertainment center, and other operations. The operation of the vehicle system 80 is similar to that described previously with reference to FIGS. 2-3, except the information display 82 with a touch screen is used to provide inputs to the vehicle system 80 in place of the dial. Also, an additional switch or option may be provided to eject or load the device into the docking station.

FIG. 6 illustrates another embodiment of a vehicle system 100 having an information display 102 within the vehicle interior and mounted to the driver instrument panel 104. The display 102 provides information to the driver regarding vehicle operations. In addition, the information display 102 is used with the personal device in a docking station 106 connected to a controller 107 of the vehicle system 100 in communication with the display 102. The docking station 106 is internal to the dashboard 108 or center console, and has an aperture 110 through which the personal device is inserted to connect to the docking station 106. In one embodiment, an ejection assembly, as is known in the art, is provided to eject the personal device from the docking station 106, and may include an ejection button.

Once the personal device is connected to the vehicle system 100, it is controlled using switches 112 on the steering wheel, voice commands, or any combination thereof providing inputs to the controller 107. The operation of the vehicle system 100 is similar to that described previously with reference to FIG. 5.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention. Additionally, features of various implementing embodiments may be combined to form further embodiments of the invention.

What is claimed:

1. A vehicle system comprising:
a docking station for receiving a personal device;
a controller in communication with the docking station; and
a display interface for a vehicle in communication with the controller, and configured to present at least one menu option from the personal device for occupant selection to control the operation of the personal device to perform the operation in response to the occupant selecting the at least one menu option.

2. The vehicle system of claim 1 wherein the docking station is adapted to receive a telephone.

3. The vehicle system of claim 1 wherein the display interface comprises a touch screen.

4. The vehicle system of claim 1 further comprising at least one switch located on the steering wheel, in communication with the controller to allow for selection of the at least one menu option displayed on the display interface to control the operation of the personal device.

5. The vehicle system of claim 1 further comprising a dial connected to the controller, having both a rotational input and a push input to control the controller to transmit at least one control signal to control the personal device to perform the operation in response to the occupant selecting the at least one menu option.

6. The vehicle system of claim 6 wherein the dial comprises a face as an additional display screen.

7. The vehicle system of claim 1 wherein the docking station further comprises a data connection system to interface with the personal device.

8. The vehicle system of claim 1 wherein the docking station further comprises an ejection assembly to eject the personal device from the docking station.

9. The vehicle system of claim 1 wherein the display interface is adapted to be mounted on an instrument panel of the vehicle.

10. The vehicle system of claim 1 wherein the display interface is adapted to be mounted on a dashboard of the vehicle.

11. The vehicle system of claim 1 wherein the controller is in communication with a vehicle controller to receive a vehicle state input.

12. The vehicle system of claim 11 wherein the controller is configured to operate the system in a park mode based on the vehicle state input.

13. The vehicle system of claim 12 wherein the display interface is configured to present the at least one menu option relating to at least one of data and program applications on the personal device during the park mode.

14. The vehicle system of claim 11 wherein the controller is configured to operate the system in a drive mode based on the vehicle state input.

15. The vehicle system of claim 14 wherein the controller is configured to limit the display interface to present the at least one menu option relating to at least one of data and applications on the phone during the drive mode, and configured to disable at least one of text, email, and internet.

16. The vehicle system of claim 15 wherein at least one of phone and navigation are enabled during the drive mode.

17. The vehicle system of claim 1 further comprising a voice command system in communication with the controller for receiving voice inputs from the occupant to control the operation of the personal device.

18. A method comprising:
connecting a personal device to a controller in a vehicle;
presenting at least one menu option from the personal device for occupant selection via an interface display; and
controlling the operation of the personal device using a control signal generated in response to the occupant selecting the at least one menu option.

19. An information display system for a vehicle comprising:
an information display; and
a controller connected to the information display and configured to connect to a personal device;
wherein the information display is configured to display one of a plurality of selectable display levels from the personal device for occupant selection; and
wherein the controller is configured to receive and selectively transmit the plurality of selectable display levels from the personal device to the display, and the controller is also configured to receive at least one occupant input corresponding to one of the plurality of selectable display levels and transit the at least one input to the personal device.

20. The information display system of claim 19 further comprising at least one display control switch, wherein the occupant input corresponds to activation of the of the least one display control switch.
